(19) United States
(12) Patent Application Publication
(10) Pub. No.: US 2015/0081043 A1
(43) Pub. Date: Mar. 19, 2015

(54) System for Control Logic Management

(71) Applicant: Broadcom Corporation, Irvine, CA (US)

(72) Inventors: Yongbum Kim, Los Altos Hills, CA (US); Wael William Diab, San Francisco, CA (US)

(21) Appl. No.: 14/477,816

(22) Filed: Sep. 4, 2014

Related U.S. Application Data
(60) Provisional application No. 61/880,035, filed on Sep. 19, 2013.
(60) Provisional application No. 61/930,319, filed on Jan. 22, 2014.

(51) Int. Cl. G05B 15/02; H04L 29/08

(52) U.S. Cl. CPC G05B 15/02; H04L 67/10
USPC 700/19

(57) ABSTRACT

A system for control logic management may include a first control element and a second control element in communication over a network. The first control element and the second control element may be identified as operable within at least one control group. The control group may include a number of control elements communicating over the network. The first control element may be operable to execute control logic as part of a control loop included within the control group. The second control element may be operable within the control group to dynamically join the control loop and assume execution of at least part of the control logic previously executed by the first control element in response to a predetermined condition.

### CROSS REFERENCE TO RELATED APPLICATIONS

This application claims the benefits of priority to U.S. provisional patent application Ser. No. 61/880,035, filed Sep. 19, 2013, and U.S. provisional patent application Ser. No. 61/930,319, filed Jan. 22, 2014, both of which are incorporated by reference in their entirety.

### TECHNICAL FIELD

This disclosure relates to process control in an industrial environment, and more particularly to equipment and/or control logic management in process control.

### BACKGROUND

Process control, related automation, monitoring and/or management control in an industrial environment can involve sensing devices, actuator devices and control devices. These devices may cooperatively operate to control or monitor aspects of a process. Device and network failures or other forms of erroneous operation of these devices typically can result in downtime of the related equipment while repairs/replacements occur. For example, if a central processing unit (CPU) or other component performing monitoring and/or control fails, the associated machine, robot or the entire manufacturing line may grind to a halt.

### BRIEF DESCRIPTION OF THE DRAWINGS

FIG. 1 shows an example of a control network.

FIG. 2 is an example block diagram of a control element node.

FIG. 3 is a schematic of another example of a control network.

FIG. 4 is an operation flow diagram illustrating example operation of a control network.

### DETAILED DESCRIPTION

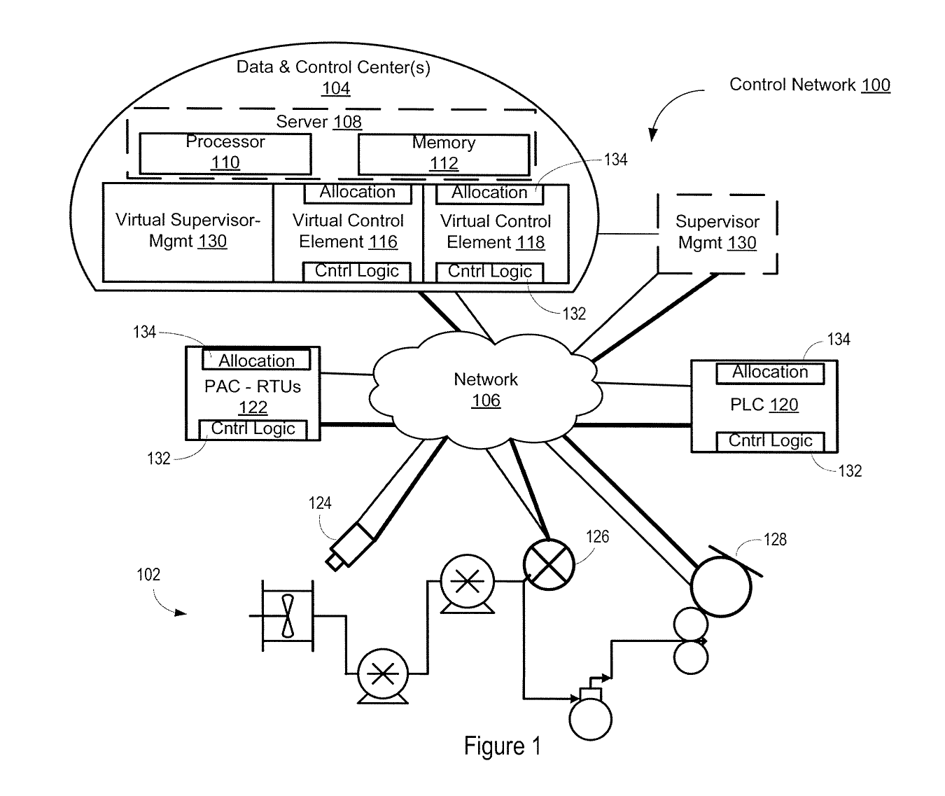

FIG. 1 illustrates an industrial environment in which a control network 100 is used to automate, monitor and/or control a process 102. The process 102 may be any industrial process or activity related to industrial production. Accordingly, the illustrated process 102 is only an example. Within the control network 100, allocation of responsibility for various aspects of control of the process 102 can be dynamically adjusted in response to predetermined conditions to avoid disruptions in the process 102. Dynamic adjustment can involve selective re-allocation of control logic execution among different control elements as predetermined conditions occur. In addition, the number and/or responsibilities of control elements functioning in a given control loop may be dynamically adjusted in real time. Such dynamic re-allocation may be based on predetermined conditions, such as conditions that are used as early indicators of situations that may result in possible disruptions in the process 102 if ignored. Transition of responsibility for execution of control logic functionality between control elements may be coordinated to occur during real time operation of the respective control loop without process interruption. Using coordinated dynamic re-allocation the control network 100 may proactively provide substantially seamless transitions of control and/or operational responsibility before an anticipated disruption in the process can occur.

The control network 100 can be fully adaptable and configurable, and includes network nodes in the form of control elements that are configured to sense, control and react to operation of the process 102. Control elements may generally include sensors, controllers, robots, actuators and/or other mechanisms and devices used in an industrial environment to provide monitoring and/or control of a process. Control elements may be included as standalone different devices operating as individual nodes within the control network 100, or may be included as functionality in nodes on the network performing other tasks, such as devices used to operate the process 102. In the example of FIG. 1, the control network 100 includes one or more data and control centers 104 and any number of control elements that are/include nodes communicating over a network 106. The control elements may be included in the data and control centers 104, or may be geographically located outside the data and control centers 104.

The network 106 may include the Internet, a public and/or private intranet(s), an extranet(s), a dedicated communication line(s) and/or any other communication configuration to enable transfer of data and commands. Communication within the network 106 may be performed with a communication medium that includes wireline based communication systems and/or wireless based communication systems. The communication medium may be, for example, a communication channel, radio waves, microwave, wire transmissions, fiber optic transmissions, or any other communication medium capable of transmitting data, audio and/or video information. The network 106 may communicate with a predetermined protocol such as an Ethernet network using TC/PIP. In other examples, any other network based communication protocol may be used. Although not illustrated, included within the network 106 may be any number of passive interconnects, intermediate networking devices, control element nodes, and any other devices used to provide functionality of the control network.

The data and control centers 104 may be a data center and may include one or more server computers 108 located in one or more separate geographic locations that are separated away from the process 102, such as on site, or off site. The server computer(s) 108 may be any form of computing device(s) capable of receiving requests and transmitting responses over the network 106. Operation of the server computer(s) 108 may be based on instructions selectively executed by at least one processor 110 operating within the server computer(s) 108. In addition to executing instructions to provide the functionality provided in computing devices operating as servers on a network, the server computer(s) 108 may execute instructions to enable operation of at least part of the control network 100. Alternatively, or in addition, at least part of the data and control centers 104 may be cloud based. Instructions executed by the server computer(s) 108 may be stored in a memory device 112.

The memory device 112 may be one or more non transitory data storage devices accessible by the server computer(s) 108. The memory device 112 may be at least one magnetic data storage device, such as a hard drive, an optical disk, a tape, or any other data storage device, and/or at least one electronic memory device such as flash memory, random access memory (RAM), or any other electronic form of data and instructions storage. The memory device 112 may be located within the server computer(s) 108 as illustrated. Alternatively, the memory device 112 may be located anywhere within the data and control center(s) 104 or any other location that allows communication with the processor 108 over the network 106. In another alternative, a portion of the memory device 112 may be located within the server computer(s) 108 and other portion(s) of the memory device 112 may be located elsewhere. The memory device 112 may include instructions, operating systems and data. The data may be in stored in the form of databases, or any other configuration, and may include historical data, process parameters, or any other information related to the control network 100.

Control elements included in the data and control centers 104 may be referred to as virtual control elements due to being geographically located remote from the process, such as off site or in a separate part of a facility, from the geographic location where the process 102 is being controlled. Alternatively, or in addition, multiple virtual control elements may be operated by a device such as a server computer. In the example of FIG. 1, a first virtual control element 116 and a second virtual control element 118 are illustrated as being included in the data and control center(s) 104. In other examples, any number of virtual control elements may be included in the data and control center(s) 104.

Each element described herein, such as the first virtual control element 116 and the second virtual control element 118 is hardware, or a combination of hardware and software. For example, each element may include and/or initiate execution of an application specific integrated circuit (ASIC), a Field Programmable Gate Array (FPGA), a circuit, a digital logic circuit, an analog circuit, a combination of discrete circuits, gates, or any other type of hardware, or combination thereof. Accordingly, as used herein, execution of an element by a processor can also refer to logic based processing by the element that is initiated directly or indirectly by a processor to complete a process or obtain a result. Alternatively or in addition, each element can include memory hardware, such as at least a portion of a memory, for example, that includes instructions executable with a processor to implement one or more of the features of the element. When any one of the elements includes instructions stored in memory and executable with the processor, the element may or may not include the processor. In some examples, each element may include only memory storing instructions executable with a processor to implement the features of the corresponding element without the element including any other hardware. Because each element includes at least some hardware, even when the included hardware includes software, each element can be interchangeably referred to as a hardware control element, such as the first virtual hardware control element 116 and the second virtual hardware control element 118.

Control elements in other geographic locations may include controllers, such as a programmable automated controller (PAC) or a programmable logic controller (PLC) 120, monitoring units such as a remote terminal unit (RTU) 122 and sensors, such as a camera 124, a pressure sensor 126, and a temperature sensor 128. In other examples, any other form of sensor may be included, such as level sensors, infra-red sensors, switches, flow sensors, machine-vision sensors, motion sensors, position sensors, or any other sensing device. Each of the controllers, monitoring units and sensors may be one or more control elements capable of executing logic or instructions to perform one or more control and/or monitoring functions within the control network 100.

The sensors may be positioned at various locations within the process 102 to sense various aspects of the process for use in management and control. In the example of FIG. 1, the camera 124 is coupled to the network 106 and monitors contents of a mixing tank, the pressure sensor 126 is coupled to the network 106 and monitors a process line pressure and the temperature sensor 128 is coupled to the network 106 and monitors a roller. As used herein, the term “coupled”, “connected”, or “interconnected” may mean electrically coupled, optically coupled, wirelessly coupled and/or any other form of association providing an interface between systems, devices and/or components.

The control network 100 may also optionally, alternatively, or in addition, include one or more supervisor management elements 130. The supervisor management element 130 may be part of the data and control center(s) 104, and/or may be a separate system communicating over the network 106. The supervisor management element 130 may manage the overall processing and control of the control network 100. In, the data and control center(s) 104, the supervisor management element 130 may be described as a virtual supervisor management element 130.

In FIG. 1, each of the control elements (including sensors, although not illustrated) may include a control logic element 132 and an allocation element 134, both of which are elements, as previously described. The control logic elements 132 may operate within at least part of one or more control loops within the process 102. Control loops within the process 102 may include one or more devices that direct, manage, command, monitor and/or regulate the behavior of part of the process 102. For example, control loops may be closed loop control or open loop control, such as feed forward control and/or feedback control that is used in industrial productions for controlling actuators, such as equipment or machines. The allocation elements 134 may be used to monitor and control which of one or more control logic elements 132 are operational within one or more of the control loops. Thus, the allocation elements 134 may be cooperatively operated to maintain and coordinate adjustment of assignment of responsibility for a control loop, or a portion of the functionality of a control loop to one or more control elements.

Using the control logic elements 132 and the allocation elements 134, the control network 100 may include control redundancy and/or coordinated dynamic allocation capabilities. Accordingly, in response to a predetermined condition, such as a communication or hardware disruption or failure, operation of the parts of the control network 100 may be dynamically re-allocated in a synchronized fashion to avoid disruption of the underlying process. In addition, based on predetermined conditions, such as a time critical network latency threshold, the control network may proactively migrate at least part of the control logic to other control elements in advance of issues affecting operation of the underlying process.

In an example embodiment, any control element running at least part of a control loop can have a counterpart control element in the data and control center(s) 104 that supports similar functionality. In another example, two or more control elements outside the data and control center(s) 104 may provide counterpart management and/or control support for one another. Dynamic reallocation may include transfer of responsibility for at least part of a control loop between counterpart control elements in response to a predetermined condition. In this example, since counterpart control elements are available, state data may be redundantly created in different control elements or state data may be transferred between counterpart control elements over the network 106 such that control functionality allocated from a first control element to a second control element may be seamlessly transitioned.

Alternatively, or in addition, in an example embodiment control elements may be formed in control groups. The control groups may include one or more control elements that cooperatively operate as part of one or more control loops. For example, a PLC control element 120 and a sensor control element 128 may communicate over the network 106 to form a control group to control the speed of a variable speed pump. In other examples, multiple control elements may be included in a control group, including control elements in the data and control center(s) 104 and/or control elements operating as intermediate nodes between other control elements.

Control logic executed in at least part of one or more operational control loops can be migrated among different control elements based on a predetermined condition such as to address load balancing on control elements, based on control loop timing constraints and/or based on expansions and/or alterations in one or more control loops. Such dynamic control logic migration can be performed/directed by coordinated operation of individual control elements, coordinated operation of control groups, a master control element, a supervisor management element 130, and/or some combination.

Load balancing may involve monitoring and adjusting the level and/or complexity of processing occurring within particular control elements in a control group by re-allocating functionality among the control elements within the control group, and or adding one or more control elements to the control group in order to optimize overall operational functionality of the control loop(s). For example, a first control element included in a control group may have a heavy processing load, whereas a second control element included in the control group may have similar processing capability, but may have little or no processing load. Thus, in this example, the imbalance in process loading within the control group between the first and second control elements can be addressed by re-allocating part of the control logic used in the processing performed by the first control element to the second control element.

Control loop timing constraints can involve monitoring communication timing constraints or latency, such as network communication traffic between control elements, or within control elements, in applications such as time critical processes. Alternatively, or in addition, control loop timing constraints can involve monitoring responsiveness of control loops and/or individual control elements. Responsiveness may be affected by processing, input/output signal communication, measurement parameter availability/timing, control loop responsiveness, packet based network communication latency, and/or any other variables affecting control loop and/or control group performance. Violation of control loop timing constraints or latency can be determined based on predetermined conditions, such as going outside of threshold latency timing. Such threshold latency timing may be based on control loop effectiveness tolerances, control loop delay tolerances, or other process related parameters affecting control performance. Different control loops and/or control elements may have different predetermined conditions, which may be monitored.

In an example, a virtual control element within the data and control center(s) 104 may be operating in a control loop where network latency in providing control output signals based on changes in a sensor input exceed a predetermined threshold latency timing parameter. In this example, all or part of the control loop functionality being handled by the virtual control element may be dynamically re-allocated to a downstream control element, such as an intermediate node, that is closer, such as fewer network hops, to the sensor and/or the control element. Re-allocation may be based on determination by the first control element, or some other part of the control network 100, that such re-allocation will bring the latency within desired limits. In another example a first control element that includes a sensor may be providing suspect information, and the first control element or a second control element or some other part of the control network 100 may dynamically shift or reallocate all or some part of the control logic to another control element in the network that includes a sensor so that the process being controlled is unaffected.

Expansions, contractions, and/or alterations in one or more control loops can involve adding or subtracting hardware, such as sensors, control elements, processors, memory, or any other devices involved in process control. Alternatively, or in addition, expansions, contractions, and/or alterations in one or more control loops may involve re-allocation of control loop functionality among previously operable control elements. Such expansion, contraction, and/or alteration may be based on the previously described predetermined conditions, and/or predetermined conditions related to a reactive control mode in which the control network 100 anticipates network communication flows, control demands and other such process related predetermined conditions and makes adjustments to re-arrange and/or adjust control logic to accommodate different situations. Accordingly, the control network may be adaptively reactive to changes in the process configuration. For example, a process may be changed from manufacture of a first widget at a first throughput rate to manufacture of a second widget at a second throughput rate, and the control elements may be dynamically reconfigured in the reactive control mode to accommodate the changes in control logic configuration. In another example, a first control element may include a sensor that is diagnostically or otherwise determined to be functioning incorrectly. In this example, the first control element may operate the control loop without the sensor or control element, or dynamically replace the sensor or other control element with other hardware by communication over the network.

Accordingly, a physical end-to-end network based control infrastructure may have a counterpart fall back or redundant infrastructure that is dynamically configurable to react to network, process and hardware pre-determined conditions. Reallocation may be to operations within other control elements, and/or the data and control center(s) 104, either onsite or offsite. Similarly, any virtual control infrastructure element may have one or more counterpart virtual elements for similar purposes elsewhere in the control network 100. If there are failures or malfunctions of a group of nodes, the control group(s) can be dynamically reconfigured on the fly and/or reconfigured automatically without process downtime. Using this dynamic control logic migration, control functions across one or more control elements, such as instances that are launched, can be moved or reallocated, and corresponding sensors reconfigured, and the like, to maintain the operation integrity of the control loop(s). Some operational functionality among control elements can be performed, while operational performance of other control elements can be re-allocated, limited, or curtailed completely. Computational processing of control elements, such as sensors, can be increased or decreased dynamically in accordance with predetermined conditions. For example, sensor computation processing can be increased in response to predetermined conditions such that sensors providing only sensing are made responsible for performing control loop functions. In an example embodiment, predetermined conditions, such as related to energy utilization of sensors, may be used to determine when a sensor should be operated in a passive mode performing only a sensing and data transmission function, and when control logic functionality should be reallocated to the sensor.

Reallocation of control logic among control elements may also be based on consideration of the processing functionality of the control elements in a control group or control loop. Control elements with limited processing capability may be dynamically allocated portions of control logic that align with available processing capabilities. Alternatively, or in addition, the complexity of control logic may be dynamically adjusted in accordance with the processing capability of a control element. For example a control loop utilizing three sensors and multi-variable control in a virtual machine PLC using feed-forward and feedback control may be dynamically simplified to a single sensor and single variable feedback control when the corresponding control logic is re-allocated to a control element, such as a sensor with limited processing capabilities.

In another example, maximum transmission unit (MTU) of a communication protocol of the network 106 may be dynamically scaled in accordance with the control elements being used in a control group and/or control loop. Thus, a larger number of bytes of data may be passed in each protocol data unit (or data packet) where the communication interfaces of the control elements are supportive, and the number of bytes may be scaled to relatively smaller number of bytes to accommodate communication interfaces with lesser processing capabilities. Alternatively, or in addition, the volume of data being communicated (such as the quantity of packets) may be dynamically altered in accordance with the processing power of the control elements in a control loop. In an example embodiment, upon association with the network 106, control elements may communicate with a server, such as in the data and control center(s) 104 to download a communication protocol configuration that includes protocol data unit parameters that set the MTU. During operation, as different control loops and/or control groups are re-allocated, the communication protocol configuration of control elements may be dynamically updated with different corresponding protocol data unit parameters to maintain communication efficiency. Alternatively, or in addition, the protocol data unit parameters may by dynamically adjusted due to network communication conditions. In this example, based on predetermined conditions, such as per-packet processing delays or packet corruption due to the size of the protocol data units, the control network may dynamically adjust the protocol data unit parameters to adjust minimum latency or delay.

Dynamic virtual reallocation of control logic among control elements in one or more control groups may also be used for fault isolation by systematic reallocation of portions of control logic once a predetermined condition identifies an issue, such as a latency issue, a control responsiveness issue or a hardware issue. In example embodiments, portions of control logic may be dynamically allocated in a sequential fashion to different control elements to determine when the issue is eliminated, thereby identifying the control element(s) and/or communication link creating the issue. In these embodiments, for example, fault isolation, such as an infected virtual machine (VM), gross misbehavior (fault isolation), and/or quarantine mode (QT) can be utilized. Accordingly, the control network 100 can provide an opportunity to switch the control logic configuration in advance of an upcoming, anticipated or potential quarantining.

The nodes within the control network 100 may also support legacy hardware and systems such as conventional PLC/PAC/RTU/MTU's configurations. For example, redundancy can be provided by the control elements to parallel any physical legacy unit with a virtual counterpart that operates on any control element or node within the network. In example embodiments, the virtual counterpart can emulate each such physical node including consuming the underlying control logic in native format. Also, a simulation counterpart for network history can be downloaded.

Control elements that can include control logic and associated sensors used to control a part of the process, such as an actuator, can be shadowed by counterpart control elements. Thus, control loops and/or control groups in the control network 100 reach beyond local control, such as machine/robot control. In example embodiments, counterpart control elements can be running in a shadow operation mode in which independent state data can be developed. In shadow operation mode, control elements can be in a monitoring operation in which independent analysis of inputs result in independent control outputs, which are not output to actuators in the process. Due to the shadow operation, the counterpart control elements can quickly take over when necessary or desired. Thus, substantially instant transition can be achieved by maintaining the counterpart control elements in an operational state, which allows local control logic performance to be monitored. Upon detecting a predetermined condition, such as a malfunction or anticipated malfunction, re-allocation of functionality can occur seamlessly, and may include alerts for system administrative servicing. Alternatively, such a transition may be triggered by a predetermined condition created manually, such as by a system administrator. In any condition, in the shadow operation mode, control inputs such as from sensors and control outputs, such as to actuators can be accessible via network pathways that can be routed over the network 106 to one or both of the local logic processing core and the remote counterpart.

In embodiments, instances of control logic can be activated and deactivated to address dynamic control logic migration such as load balancing, control loop timing constraints, or control group functionality expansions/alterations. That is, control logic can be dynamically instanced/launched on any one or more particular pathway nodes (control elements). For example, control logic may migrate functionality (control element operations, with or without underlying control logic code depending on if the code is already instantiated on the counterpart control element) to address load balancing concerns associated with processing or communication resources at any node. Similarly, a control pathway through the network 106 may exist between a virtual control element, which may include virtual machine (VM) operation in the data center using control logic, and a control element, such as a PLC chip, which may have thin logic necessary to respond to control commands. Predetermined conditions, such as loading issues may cause a migration of such VM control logic, in whole or in part, from the data and control center(s)/cloud to such the control element, such as the PLC chip.

In embodiments, the same or similar control logic may be preloaded in both places and merely selectively activated for handover. Migration can also be triggered by other predetermined events, such as power availability, malfunction, underlying activity levels or events, or any other process related operations. Moreover, having multiple “versions” of a given control logic instanced at various multiple network nodes in the form of control elements allows the (re)configuration process to dynamically switch operations to any of the underlying nodes on the fly without control logic interruption that could cause process interruption or instability.

In example embodiments, at least part of the control logic operating on a first control element may be instanced on a second control element. Such instancing may involve dynamic migration of the state data from the first control element to the second control element. Alternatively, or in addition, the second control element may perform shadow control to create or adjust the state data to current operational conditions. Once the second control element is a fully operational counterpart node with current state data, control loop operation may be migrated to the second control element, thereby creating a “make before break” approach to process control using a counterpart control element. In embodiments, for example, the control network 100 and underlying nodes can dynamically auto-configure control logic for migration around the network 106 ahead of anticipated events using predetermined conditions as triggers. Such predetermined conditions that operate as migration triggers (including anticipation), may be developed to allow the control system to decide when/where/how to migrate control logic. Since the control logic and current state data may be migrated ahead of possible process instability issues, seamless migration can occur without having to take down a process being controlled.

Operational control of migration may be directed by a master control element, such as the supervisor management element or virtual supervisor management element 130. Alternatively, or in addition, one or more control elements operating as nodes in the control network 100 may be selectively identified as a master control element. Thus, one or more master control elements, such as PAC's (Programmable Automation Controllers), can be tasked to handle its own dynamic control logic allocation, such as in individual control loops, and/or control element members of a control group in which the master control element resides. For example, a node can self-elect itself to be the master control element by maintaining a registration of control group management information, and optionally providing secure credentials in such registration maintenance. The registered control group management information may include current control group and control element configuration, which may include control loop and/or control group operational information, such as routing tables, switching tables, and network topology; physical geographic locations of control elements, such as a locations table; redundant control element nodes; counterpart control element nodes; and/or performance based parameters for each of a number of control element nodes. In addition, registered control group management information may include available control elements that may or may not currently be part of the control group and/or control loops, other control groups, other master control elements, or any other control network related information that could be used to make control logic reallocation decisions.

Upon the occurrence of a predetermined condition, the master control element can determine and direct selective migration of control logic to dynamically re-arrange one or more control loops through communication to the nodes over the network 106. Determination and selective migration by the master control element may be based on projections of adjustments that will impact the predetermined condition. Such projections may be based on dynamic simulation, logic tables, predetermined reactions to given predetermined conditions, or any other process or procedural method for determining a response to a predetermined condition.

The master control elements may allocate control loop responsibility among the control elements and direct reconfiguration, commissioning, transition of control responsibility among control elements and any other management tasks related to re-allocation of control logic among the control elements. In the situation where a master control element fails to perform within predetermined parameters, malfunctions or is otherwise fully or partially unavailable for service, an alternate master control element may elect, or be elected, to be the master control element. Such an election may be predetermined, or may be dynamically determined by the control elements based on operational parameters, such as current configuration of the control network, available processing capability/data storage capability of control elements in a control group, robustness of communication pathways in the network 106, configured system priorities, or any other performance based parameters. Following election, control loop and control group management information may be migrated to the newly elected master control element.

A master control element may create or update control group management information. Control group management information may be received over the network from any of a number of sources, which may include stored control group management information records from one or more other master control elements (or other control elements), from a common storage repository, such as a control group management information repository maintained by, for example, the supervisor management element 130, and/or from other control elements, such as by multi-casting of capability requests to potential control elements for a control group, and/or querying for network topology and network performance information. Alternatively, or in addition, multiple instances of management information, such as routing tables and switch tables, and control element capabilities can be maintained and accessed across multiple control element network nodes.

Reallocation by a master control element may be performed dynamically by the master control element based on assessment of predetermined condition(s), operational conditions and/or control group management information. Alternatively, or in addition, reallocation may be based on a predetermined re-allocation schedule or logic tree available to the master control element. Dynamic determination of re-allocation may also be based on simulation of a proposed control logic reallocation by the master control element, or another element in the control network, such as the supervisor management element 130 to project the effect of different reallocation scenarios. Dynamic reallocation may also be shared between master control elements. For example, an existing master control element managing control logic relating to several control elements, such as sensors and actuators may dynamically take on responsibility for control logic re-allocation processing of additional control elements, control loops, and/or control groups of another master control element based on a predetermined condition. For example, in response to a predetermined condition, the existing master control element may include control logic that specifies, for example, a re-allocation behavior where another control element, such as a sensor, is tasked with additional control logic responsibility, or where a backup or a previously un-enlisted other control element, such as a sensor, is brought into an existing control group.

The methods, devices, and logic described above may be implemented in many different ways in many different combinations of hardware, software or both hardware and software. For example, all or parts of the system may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. All or part of the logic described above may be implemented as instructions for execution by a processor, controller, or other processing device and may be stored in a tangible or non-transitory machine-readable or computer-readable medium such as flash memory, random access memory (RAM) or read only memory (ROM), erasable programmable read only memory (EPROM) or other machine-readable medium such as a compact disc read only memory (CDROM), or magnetic or optical disk. Thus, a product, such as a computer program product, may include a storage medium and computer readable instructions stored on the medium, which when executed in an endpoint, computing system, or other computing device, cause the device to perform operations according to any of the description above.

The processing capability of the system may be distributed among multiple system elements, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library, such as a shared library (e.g., a dynamic link library (DLL)). The DLL, for example, may store code that performs any of the system processing described above.

In embodiments, control elements in the control network 100 may include functionality to perform an adaptive self-repair function when a loss of communication with the network is sensed. For example, if a control element is communicating over a communication port via a cable, and the cable becomes damaged, such as becomes shorted or becomes an open circuit, the control element may take corrective action. The corrective action may entail attempting to use the damaged cable to continue communications until a repair to the cable can be completed. In this situation, the control element can detect the nature of the cable damage and perform compensating actions in an effort to continue using the damaged cable for communication.

During operation, upon detection of a short circuit, a short to ground condition, or an open circuit condition in the communication cable, the control element may enter a communication failure mode and selectively choose the wires upon which communication can be performed. Using a testing and selection process in which communication signals are applied to selected wires, the control element may identify available pathways (wires) in the damaged cable which are not shorted or open, and therefore are still available for communication. The control element may be aware of a pinout of the communication cable so that combinations of different pins may be selectively used in attempts to test for a communication path. The test signals may be communicated to another control element and/or device in the network requesting acknowledgement of receipt of the test signal. Accordingly, upon transmitting a test signal, the control element may await reception of a response from the another control element and/or device to which the test signal was sent for a predetermined period of time. Upon the predetermined period of time elapsing, the control element may select a different pair of wires and send another request. This process may continue until viable communication paths are identified, or until all possible combinations of the available communication paths have been exhausted. In addition or alternatively, the control element may use wires that are identified as open circuits to form an antenna for use in wireless communication as an available communication path.

Using the identified communication paths, different communication techniques may be tested by the control element to determine viable communications for the identified available paths. For example, the physical layer of the control element may be adaptive to overcome the communication defect. The communication protocols being tested may be standard communication protocols, or proprietary communication protocols, such as a proprietary communication mode for a communication failure mode.

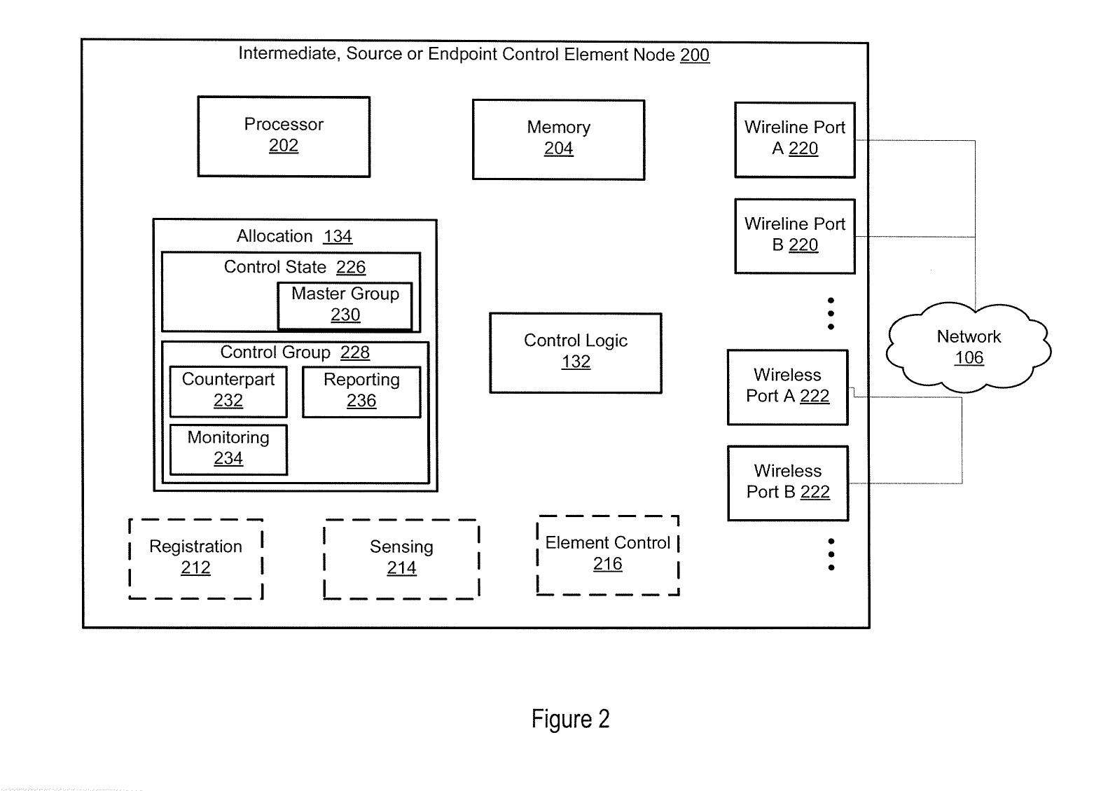

FIG. 2 is a block diagram of an example control element 200. Within the network, control elements may be an endpoint node, such as a sensor, an actuator, or an RTU; an intermediate node, such as a network switch a network router or any other node in the network that is in a communication path between an endpoint node and a source node; and a source node, such as a PLC, PAC, or a virtual control element. The control element 200 can include a processor 202, and a memory 204. In addition, the control element 200 may include the control logic element 132 and the allocation element 134, and one or more communication interfaces 208. In addition, in some embodiments, the control element 200 may include a registration element 212, a sensing element 214, and an element control element 216.

The processor 202 may be any form of device(s) or mechanism(s) capable of performing logic operations, such as a central processing unit (CPU), a graphics processing unit (GPU), and/or a digital signal processor (DSP), or some combination of different or the same processors. The processor 202 may be a component in a variety of systems. For example, the processor 202 may be part of a personal computer, a workstation or any other computing device. The processor 202 may include cooperative operation of one or more general processors, digital signal processors (DSPs), application specific integrated circuits (ASICs), field programmable gate arrays (FPGA), digital circuits, analog circuits, and/or combinations thereof, and/or other now known or later developed devices for analyzing and processing data. The processor 202 may implement a software program or firmware, such as code generated manually or programmed. The processor 202 may operate and control at least a portion of the control element 202.

The processor 202 may communicate with the elements of the control element 200 via a communication path, such as a communication bus. The communication bus may be hardwired, may be a network, and/or may be any number of buses capable of transporting data and commands. The elements and the processor 202 may communicate with each other on the communication bus.

The memory 204 may include a main memory, a static memory, and/or a dynamic memory. The memory 204 may include, but is not limited to computer readable storage media, or machine readable media, such as various types of non-transitory volatile and non-volatile storage media, which is not a signal propagated in a wire, including but not limited to random access memory, read-only memory, programmable read-only memory, electrically programmable read-only memory, electrically erasable read-only memory, flash memory, magnetic tape or disk, optical media and the like. In an example, the memory 204 includes a cache or random access memory for the processor 202. In addition or alternatively, the memory 204 may be separate from the processor 202, such as a separate cache memory of a processor, the system memory, or other memory. The memory 204 may also include (or be) an external storage device or database for storing data. Examples include a hard drive, compact disc (“CD”), digital video disc (“DVD”), memory card, memory stick, floppy disc, universal serial bus (“USB”) memory device, or any other device operative to store data.

The memory 204 is operable to store instructions executable by the processor 202 and data. The functions, acts or tasks illustrated in the figures or described may be performed by the programmed processor 202 executing the instructions stored in the memory 204. The functions, acts or tasks may be independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The communication interface 208 may be any mechanism or device providing communication over the network 106 and/or to other devices. In FIG. 2, the communication interface 208 includes first and second wireline ports (A&B) 220 and first and second wireless ports (A&B) 222. In other examples, any number of ports or any configuration capable of communicating over the network 106 may be included in the control elements. In an example embodiment, the wireline ports may be configurable full duplex ports cable of communication within any communication system, such as an Ethernet local area network (LAN). The ports may operate with a protocol for example a transport layer protocol, such as transmission control protocol (TCP) and user datagram protocol (UDP). Each port may be identified by a port number which may be used to uniquely identify the port in a communication session over the network 106. For example, a port number and an address of a control element, such as an internet protocol (IP) address may provide a unique destination address within the network 106 for a communication session.

Multiple ports may be used on any control element. For example, with a PLC control element, a first port may be used for communication with a control element that includes a sensor, and a second port may be used for communication to an actuator or another control element to form a control loop. The control logic 132 may operate at least part of a control loop using the communication ports. For example, the control logic 132 may perform packet based communication to receive data, such as sensor data, and output control data, such as setpoint data to an actuator. The communication interface 208 may also include input/output capability such as analog and digital signal capability, as well as signal conversion capability such as analog-to-digital, digital-to-analog, scaling, frequency, or any other conversion technique. The communication interface 208 may also include communication capability in other protocols, such as RS232, RS422, RS485, Firewire, Bluetooth™, ring bus, proprietary protocols, and/or any other communication protocol, as well as protocol conversion capabilities to convert from one protocol to another.

The allocation element 134 may assist in management of the control logic and the control element within a control network. In FIG. 2, the allocation element 134 includes a control state element 226 and an election element 228. In other examples, any number of elements may be used to depict the functionality of the allocation element 134.

The control state element 226 may manage the control state of the control element. The control state includes variables associated with the control element's participation in a control loop. Such variables may include setpoints, gains, register values or states, received measurement variables, and any other data and parameters associated with the state of the functionality being provided by the control element within one or more control loops. In addition, the control state element 226 may control execution of the control logic. For example, the control state element 226 may disable execution of the control logic, disable receipt of input signals and/or disable transmission of output signals generated by the control logic, or perform any other activity to deactivate all or a part of the control logic in response to a predetermined event. In an example, the predetermined event may be an indication that another control element is ready to take over execution of the control logic such that a synchronized transition of operation of the control logic may occur without disturbing the operating process on which the control is implemented. Further, the control state element 226 may perform analysis of received predetermined conditions, and initiate appropriate dynamic action(s) to proactively avoid anticipated issues that may affect the process being controlled. Further, the control state element 226 may include a master element 230.

The master element 230 may maintain the status and related management of the control elements within one or more control groups. Status may refer to whether the control element operates as a master control element in a control group. In an embodiment, the master element 230 may elect the control element as the master control element. In addition, the master element 230 may identify a group of control elements as a control group. The control group may, for example, operate together within a control loop, operate within a certain part of an industrial process, perform similar functionality, or be any other organizational grouping of control elements. Establishment of the control element as a master control element may be established by, for example, multicasting of such information to the members of the control group over the network 106 using the communication interface 208. Identification of the control group may be based on optimization of communication pathways within the network, and/or optimization of control loop functionality. Optimization of communication pathways may involve consideration of throughput or latency, network traffic patterns, number of hops, or any other communication related variables. In other example embodiments, some, or all, of the establishment of the master control element and corresponding control group may be performed external to the control element, such as by the virtual supervisor management element 130.

The master element 230 may also coordinate and implement the timing to perform synchronized transitions of control logic when re-allocation of the control logic between control elements, or within control elements is occurring. In addition to confirmation that the control logic and all associated state data have been populated in the new control element being transitioned to, the master element 230 may also coordinate the timing for the changeover of responsibility for the operation of the control logic being reallocated. For example, the master element 230 may communicate with the control state element 226 in the respective control elements to initiate the enabling and disabling of outputs. Since the dynamic reallocation occurs in real time, while the process being controlled continues to operate, the timing for the reallocation may be based on process related parameters, such as process variables being within a range for a predetermined period representing relatively steady state operation of the process, or control loops having variations in control outputs below a predetermined threshold for a period of time. Alternatively, or in addition, coordination of transition of control logic among control elements may be performed by the supervisor management element 130.

In at least some embodiments, the control group element 228 may include a counterpart element 232, a monitoring element 234 and a reporting element 236. In other examples, any number and form or elements may be included to describe similar functionality.

The counterpart element 232 may be used when a control element is cooperatively operated with a counterpart control element, or is available as a counterpart control element. Accordingly, the counterpart element 232 may allow the control logic of the control element to operate as a clone of control logic operating in another control element. In example embodiments, the clone control logic may perform shadow control such that the state data of the counterpart control element is substantially similar even though the counterpart control element is not actively operating in the control loop. Since the state data is substantially similar, upon occurrence of a predetermined conditioned, the counterpart control element may be switched out of shadow control to active control within a control loop without significant interruption of the industrial process.

For example, the counterpart element 232 may suppress the control outputs of the control logic of the control element performing shadow control until synchronized transfer of at least a part of the control logic occurs such that control outputs of one control element are suppressed at substantially the same time control outputs are enable at a second control element previously operating as a clone. In other embodiments, the counterpart element 232 may manage the receipt and implementation of state data within the control logic of a clone control element prior to transfer of active operation of at least part of the control logic in order to allow for a substantially seamless transition of operation of the control loop between control elements. In addition, control logic may be transferred, stored and initiated in a control element using the counterpart element 232 just ahead of the control element dynamically taking on control responsibilities within one or more control loops.

The monitoring element 234 may be involved in monitoring control logic operation in other control elements. Such monitoring may be based on predetermined thresholds such as output levels, operating conditions, latency in operation, or any other parameters that indicate the performance of a monitored control element in one or more control loops. When the monitoring element 234 identifies parameters outside of the predetermined threshold, a predetermined condition warranting transfer of at least part of the control logic to other control elements may be created. Such monitoring may be based on monitoring of control inputs, control outputs, communication speed, network traffic, or any other control performance based parameters. Alternatively, or in addition, comparison to operational parameters of control logic operating as shadow control logic may be used during monitoring. Thus, the monitoring element 234 may determine the appropriate time for dynamic transitioning of responsibility between control elements. In addition, the monitoring element 234 may determine when dynamic migration of at least part of some control logic may result in improved responsiveness of a respective control loop. Thus, the monitoring element 234 may identify control logic that may be re-allocated to one or more other control elements to alleviate anticipated future issues. Working cooperatively with the counterpart element 232, transitioning control logic between control elements may occur dynamically before an issue in the corresponding process occurs. Such a transition may occur in a synchronized fashion to avoid process disruptions. Alternatively, or in addition, monitoring similar to that of the monitoring element 234 may be performed at another location, such as at the supervisor management element 130. (FIG. 1)

The reporting element 236 may involve the capture and storage of data related to process control. The reporting element may also provide access to, and storage of, parameters used to identify predetermined conditions. In addition, the reporting element 236 may provide information and data to other parts of the network 106. For example, the reporting element 236 may alert another control element or a supervisor, such as the supervisor management element 130 of a potential issue using a packet based alert message sent over the network 106. Such an alert message may be used to initiate operation of the monitoring element 234, or may be a predetermined condition upon which re-allocation of a control logic is based.

In embodiments, the control element node 200 may also include a registration element 212. The registration element 212 may maintain information regarding other control elements, such as other control elements in a control loop or control group in which the control element is involved. In addition, or alternatively, the information maintained may be candidate control elements within the control network that may cooperatively operate with, or instead of, the control element. Such candidate control elements may be previously identified. Alternatively, or in addition, candidate control elements may be identified by the control element from the registration element 212 based on predetermined criteria. Such predetermined criteria may include processing capability, geographic location in the process, and/or network location, such as number of hops away from the control element or other identified systems or devices.

The information maintained by the registration element 212 may include hardware information, control logic information and network information on other control elements in the system. Hardware information may include processing power, memory storage capability, number/type of ports in the communication interface 208, sensing capabilities, processor usage, communication capability, and/or any other hardware related parameters that could influence capabilities and/or performance. Control logic information can include existence of clone control logic, conversion capabilities, control loop capabilities, multi-task/multi-thread capabilities, and/or any other control logic related information. Network information may include communication speed, maximum packet size, latency, number of hops away from the control element or other identified systems or devices.

The information may be maintained in a database, such as a relational database. Such information may be obtained by the control element 200 based on, for example, multicast messages to other control elements requesting such information, downloaded information, discovery, or any other mechanism or procedure.

The stored information may be used by the allocation element 134 to manage allocation of the control logic to one or more control loops, and or one or more control groups. In addition, the stored information may be used in network communication management functions, such as to avoid and/or correct latency issues in time critical control loops. Further, the stored information may be provided to other control elements and/or the supervisor management element 130 (FIG. 1) for similar purposes. Also, the stored information may be provided to other control elements as the control logic is re-allocated to provide control elements with new responsibilities with information to immediately begin to perform allocation management.

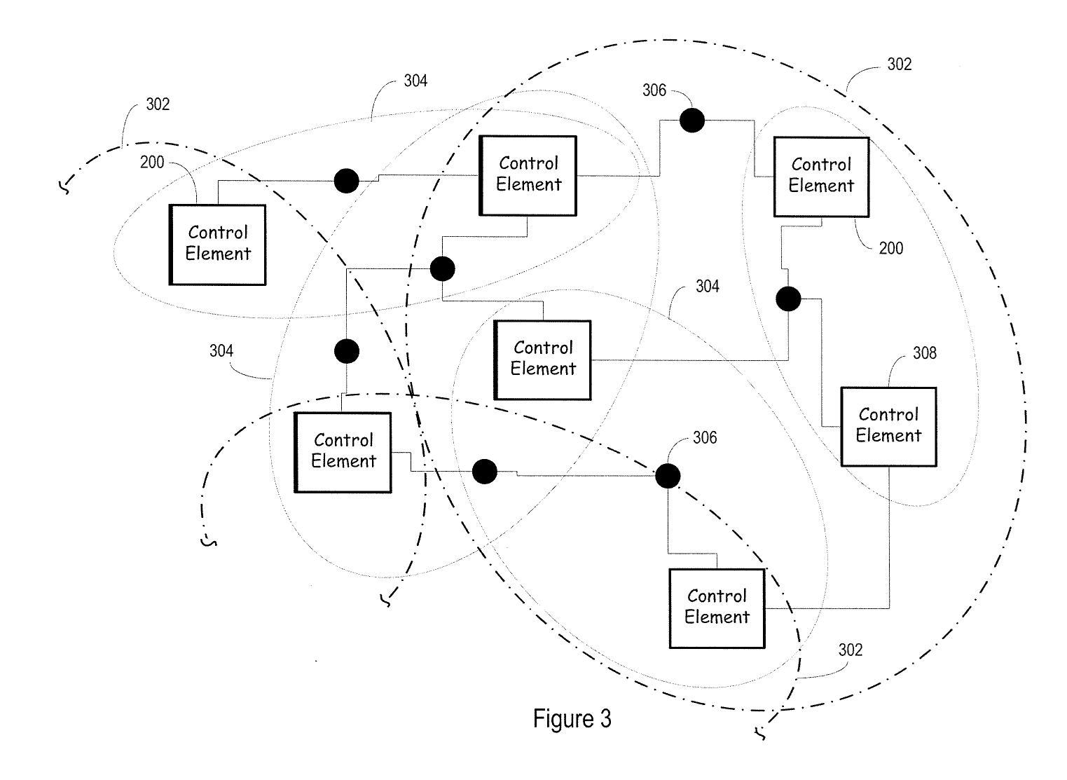

FIG. 3 is an example of a number of control groups 302 and control loops 304 containing one or more control elements 200. Each of the control elements 200 are illustrated as source nodes or endpoint nodes or intermediary nodes communicating over the network through one or more intermediary nodes 306. The intermediary nodes may be other control elements and/or network devices such as switches, routers or repeaters. Members of a control group 302 or control loop 304 may also be members of other control groups and/or control loops as illustrated.

In the example of FIG. 3, each of the control groups 302 may include a master control element 308 which may manage the respective control group, and respective control loops 304 within the respective control group. Alternatively, the supervisor management element 130 may operate as the master control element. During operation, the master control element 308 may adjust the number of member control elements in the control group based on operating conditions and/or predetermined conditions in which control logic may be dynamically re-allocated among the control elements in a synchronized fashion to avoid disruptions in the process or the control functionality. In addition, within a control group 302, the members and configuration of control loops may be adjusted based on operating conditions and/or predetermined conditions in which control logic may also be dynamically re-allocated among the control elements with coordination to avoid disruptions in the process or the control functionality.

Re-allocation or migration of control logic among the control elements 200 may be based on membership in the control loops 304 and control groups 302. In addition, since the physical locations and the network locations of control elements may be known, re-allocation of the control logic may be performed to decrease latency, such as by eliminating intermediate nodes 306. Also, since the hardware information, control logic information and network information within the control network is known, the re-allocation of control elements 200 may be determined based on projected changes in network timing, control element operation, control loop efficiency and/or control loop effectiveness. Thus, for example, additional control elements 200 from within a control group 302 may be dynamically added to a control loop 304 to increase control loop accuracy, or control elements 200, such as sensors, within a control loop 304 may be dynamically swapped for other control elements 200 in response to a predetermined condition. In addition, entire control loops 304 or control groups 302 may be dynamically removed and replaced by re-allocation of control logic in response to predetermined conditions.

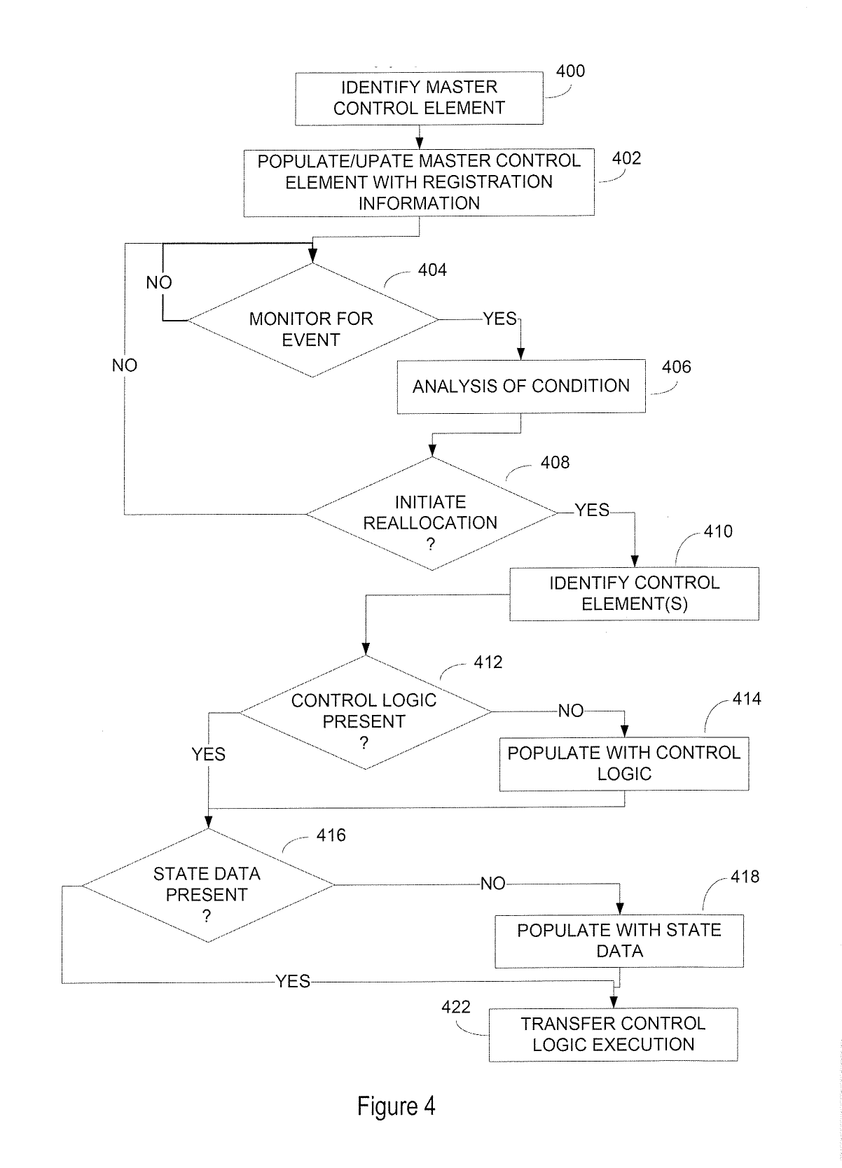

FIG. 4 is an example operational flow diagram of a control network in which control logic is selectively migrated among different control elements in response to a predetermined condition. At block 400, a control element may be identified as the master control element within a control group. Identification of a master control element may be based on: self-election by a control element in the control group; a predetermined designation; dynamic selection, such as by the supervisor management; or by peer election, such as peer election by the control elements in a control loop or control group. The registration element included in the master control element may be populated/updated with registration information such as the members of the control group, the control loops, counter control element information, and control group management information at block 402. Alternatively, the selection of a master control element may be omitted.

At block 404, monitoring for a predetermined event may occur while control logic is operating in the control elements of a control network to manage and control an industrial process. In embodiments, the control elements may be operating in control loops in one or more control groups having master control elements. If no predetermined event is identified, the operation returns to block 404 to continue monitoring. If one or more predetermined events are identified, analysis may occur at block 406 to determine if reallocation is warranted. Analysis may be performed by one or more control elements, one or more master control elements, the supervisor management element, or cooperative operation of two or more of these elements. Such analysis may include, for example, simulation of various possible migrations or reallocation of control logic, application of predetermined reallocation logic based on the predetermined event, and/or review and analysis of monitoring data collected by monitoring elements of one or more control elements.

The determination of whether to initiate re-allocation may occur at block 408. Reallocation may be dynamically determined by one or more control elements, one or more master control elements, the supervisor management element, or cooperative operation of two or more of these elements. If it is determined that re-allocation is not needed, the operation returns to block 406 and continues monitoring for another predetermined event. If initiation of re-allocation is warranted, at block 410 one or more second control elements may be identified to which at least part of control logic functionality presently being performed by one or more first control elements should be dynamically reallocated. Reallocation of control logic may include swapping devices, adding devices or reconfiguring devices in one or more control loops, and/or swapping, adding and/or reconfiguring virtual control elements, such as virtual control elements in the data/control center(s). In embodiments, reconfiguration of a corresponding control group may occur as part of the reallocation, or control logic may be reallocated to a different control group.

At block 412, it is determined if the second control element(s) already includes the control logic functionality to be reallocated to the second control element(s). For example, it is determined if the second control element(s) are counterpart control elements. If not, the second control element(s) may populated with the control logic functionality at block 414, and the operation may proceed to block 416 to determine if state data associated with the control logic is present in the second control element(s). Population of the second control element(s) with control logic may include revising existing control logic in the second control element(s), downloading over the network of all or part of the control logic to be reallocated, and/or adjusting the functionality of the control logic of the first control element(s) to align with capabilities of the control logic functionality of the second control element(s).

If, on the other hand, the control logic functionality is already present in the second control element(s), the operation may proceed directly to the block 416 to determine if the state data is present. If the state date is not present, or should be updated with current state data, the second control element(s) may be populated with state data at block 418, and the operation proceeds to block 422. Population of state data may include transfer of state data over the network, shadow operation of the second control element(s) using the inputs to the corresponding control loop and the reallocated control logic until state data has been populated, transmission over the network of selective updates to existing state data present in the second control element(s), or any other mechanism to make available current state data at the second control element(s). At block 422, synchronized transfer of execution of control logic functionality may occur from the first control element(s) to the second control element such that the second control element(s) assume execution of the control logic without interruption of control by the corresponding control loop(s).

If the state data is confirmed as being present and updated in the second control element, the operation may proceed directly to block 422 where the second controller element(s) may assume execution of the control logic previously executed by the first control element.

Various implementations have been specifically described. However, many other implementations are also possible.

We claim:

1. A system for control logic management comprising:
a first control element and a second control element in communication over a network;
the first control element and the second control element identified as operable within at least one control group comprising a plurality of control elements communicating over the network;
the first control element operable to execute control logic as part of a control loop included within the control group; and
the second control element operable within the control group to dynamically join the control loop and assume execution of at least part of the control logic previously executed by the first control element in response to a predetermined condition.

2. The system of claim 1, wherein the first control element is a master control element operable to monitor the control group and coordinate dynamic assumption of the at least part of the control logic.

3. The system of claim 1 wherein the predetermined condition comprises an imbalance in processing loading between the first control element and the second control element, and the execution of the control logic is transitioned from the first control element to the second control element during real time operation of the control loop.

4. The system of claim 1 wherein the predetermined condition comprises violation of a threshold latency timing within the control loop, and wherein selection of the at least part of the control logic for execution by the second control element is based on a projection that the threshold latency timing will no longer be exceeded after execution of the at least part of the control logic by the second control element.

5. The system of claim 1 wherein the second control element comprises an intermediate pathway node in the network between the first control element and an actuator.

6. The system of claim 5, wherein the second control element comprises a network switch.

7. The system of claim 1, wherein the first control element comprises a virtual control element executable in a data center, and the second control element comprises a programmable logic controller.

8. A method of control logic management, the method comprising:
executing control logic using a first control element in a network to control a process in an industrial environment;
identifying, in the network, a second control element capable of executing at least part of the control logic to control the process in the industrial environment;
determining a predetermined condition has occurred;
synchronizing dynamic transfer of responsibility for execution of at least a portion of the control logic from the first control element to the second control element in response to the determination that the predetermined condition has occurred; and
terminating execution by the first control element of the at least a portion of the control logic for which responsibility was transferred in coordination with initiating execution of the at least a portion of the control logic with the second control element.

9. The method of claim 8, wherein synchronizing dynamic transfer of responsibility comprises dynamically instancing the at least a portion of the control logic at a data center, populating state data from the first control element at the second control element; and transferring responsibility for execution of the at least a portion of the control logic from the first control element to the second control element.

10. The method of claim 8, wherein executing control logic using a first control element comprises electing the first control element as a master control element of a control group; and the master control element accessing registered control group management information comprising current control group and control element configuration information to identify the second control element.

11. A system for control logic management comprising:
a processor operable in a control element;
a control logic element executable by the processor to execute control logic for a process in an industrial environment;
a communication port executable by the processor to communicate with other control elements over a network based on the executed control logic;
an allocation element executable by the processor to determine that responsibility for execution of at least a portion of the control logic is dynamically transferred to an other control element in the network; and
a control state element executable by the processor to discontinue execution of the at least a portion of the control logic in synchronization with assumption of execution of the at least a portion of the control logic by the other control element in the network.

12. The system of claim 11, wherein the allocation element is further executable by the processor to elect the control element as a master control element and identify a group of control elements that includes the master control element and the other control element as part of a control group.

13. The system of claim 12, wherein the allocation element is further executable by the processor to maintain a location table indicative of respective geographic locations within the group of control elements, a routing table of communication routes over the network within the group of control elements, and a capacity table indicative of respective processing capacity within the group of control elements.

14. The system of claim 13, wherein the allocation element is further executable by the processor to identify a predetermined condition, and initiate transfer of responsibility for a predetermined portion of the control logic based on the predetermined condition identified.

15. The system of claim 12, wherein the master control element is operable to base selective allocation of the control logic on a plurality of operational factors, the operational factors comprising communication latency, current control element loading, and control loop timing constraints.

16. The system of claim 11, wherein the determination by the allocation element that responsibility for execution of the at least a portion of the control logic is dynamically transferred comprises the allocation element being further executable by the processor to receive an instruction over the network to transfer responsibility for the at least a portion of the control logic.

17. The system of claim 11, wherein the at least a portion of the control logic is instanced on the other control element in the network, and the control state element is further executable by the processor to communicate a current control state of the control element to the other control element, the control state comprising a current state of registers and operational parameters in the control element.

18. The system of claim 11, wherein the at least a portion of the control logic is instanced on the other control element in the network, and the at least a portion of the control logic is executed on the other control element in a clone capacity prior to transfer of responsibility, and wherein transfer of responsibility comprises enabling outputs on the other control element at substantially a same time said outputs are disabled on the control element.

19. The system of claim 11, wherein the other control element comprises a plurality of separate and independent control elements in different locations within the network, and responsibility for execution of the at least a portion of the control logic is selectively allocated among the plurality of separate and independent control elements.

20. The system of claim 11, wherein the allocation element is further executable by the processor to add a new control element to a control group that includes the control element and the other control element, and transfer responsibility for execution of at least part of the control logic to the new control element.
